(19) United States
(12) Patent Application Publication
(10) Pub. No.: US 2017/0143139 A1
(43) Pub. Date: May 25, 2017

(54) Wall Hanging System Using Multiple Devices

(71) Applicant: Marc Fattahi, Norwalk, CT (US)

(72) Inventor: Marc Fattahi, Norwalk, CT (US)

(21) Appl. No.: 14/852,275

(22) Filed: Sep. 11, 2015

(51) Int. Cl. A47G 1/16; A47G 1/17; F16M 13/02

(52) U.S. Cl. CPC A47G 1/1606; F16M 13/02; A47G 1/17

(57) ABSTRACT

A system with devices for hanging picture frames, mirrors or the like comprising a wall member cooperating with a corresponding frame member being adjustable and securable. The devices are installed in pairs, one device on each side of the frame or like. The devices have two mating halves, the upper halves affixed to the frame and the lower halves attached to a wall or other vertical surface. The devices are placed on a wall be use of adhesive and then permanently attached by screws or like fasteners. The devices permit adjustment to height and alignment by set screws and flutes. The devices prevent accidental misalignment and mis-location after installation and impede unauthorized removal.

### CROSS-REFERENCE TO RELATED APPLICATIONS

Not Applicable

### STATEMENT REGARDING FEDERALLY SPONSORED RESEARCH OF DEVELOPMENT

Not Applicable

### NAMES OF PARTIES TO A JOINT RESEARCH AGREEMENT

Not Applicable

### REFERENCE TO A SEQUENCE LISTING

Not Applicable

### STATEMENT REGARDING PRIOR DISCLOSURES BY INVENTOR OR JOINT INVENTOR

Not Applicable

### BACKGROUND OF INVENTION

Field of the Invention

This invention relates to the hanging or supporting of picture frames, mirrors or the like (all of which will hereafter be referred to as “frame” or “frames”) comprising a wall member cooperating with a corresponding frame member being adjustable and securable.

Currently when hanging frames there are problems (1) precisely locating where the frame will hang on the wall, (2) precisely aligning the frame vertically and horizontally, (3) securing the frame to the wall so that it cannot be dislodged or misaligned unintentionally and (4) securing the frame to the wall so it that cannot be removed easily by a person who does not have a right to remove it.

Description of Related Art.

There are various systems and methods available that can locate and align a frame on a wall.

These include use of a stand that holds or supports a frame. The stand with the frame can be placed in a selected position along a wall at the desired horizontal location where the stand then can be extended to raise the frame to the desired vertical position on the wall. The location of the frame or the hangers for the frame can be marked on the wall. The hangers are then attached to the wall by reference to the marks.

There are also devises that hold a frame by its wire and allow an installer to suspend that frame to a position on a wall and then mark the location of the placement of the hooks or nails on the wall. This is the system and method employed by Hang and Level™ produced by Under the Roof Decorating.

A frame can be located on a wall by installing a rail on that wall above the location of the frame and suspending wires from the rail that attach to hooks on that frame with the length of the suspended wire being adjustable to permit the frame to be level and at the desired height.

There are also systems that employ Velcro® (or similar fabric hook and loop fasteners) strips with adhesives on the side without Velcro. The two strips are attached on their Velcro sides, one strip is attached to a frame by the adhesive, the frame is then attached to the wall with the adhesive on the other strip. That permits an installer to directly place a frame on the desired location on the wall. Command™ Picture Hanging Strips produced by 3M uses this system and method.

There are various systems and methods available for hanging a frame on a wall.

These include the traditional use of hooks or hangers attached to a frame. Wire can be then secured to the hooks or hangers attached the frame. The frame is then suspended by the wire that hangs from hooks, hangers, screws or nails attached to a wall.

Brackets or sawtooths can be attached to a frame and a frame can be suspended by hanging the brackets or sawtooths on hooks, hangers, screws or nails attached to a wall.

There is also a system that employs double rails with one rail attached to the back of a frame and the other rail attached to the wall. The frame is suspended by nesting the rail attached to the frame inside the rail attached to a wall.

Velcro strips attached by adhesive to a frame and a wall as described above for Command™ Picture Hanging Strips is another system for hanging a frame.

There are various systems and methods available for securing a frame on a wall.

These include a bracket attached to the bottom of a frame that is secured to a wall by a special “T”-shaped screw placed in a wall. When the frame is placed on the wall the T-shaped screw fits through the bracket and when the T-shaped screw is turned 90° by a special tool the frame cannot thereafter be removed without use of the special tool.

### SUMMARY OF INVENTION

The devices in this wall hanging system allow the level installation of a frame on a precise location on a wall or other vertical surface (all of which will hereafter be referred to as “wall”). This is accomplished by using two identical devices with one device attached to each side of a frame. Each device has two halves: an upper half which is attached to a frame by screws or like fasteners (all of which will hereafter be referred to as “screw” or “screws”) and a lower half that is initially attached to a wall by adhesive and then secured permanently to a wall by screws.

Once a frame is installed on a wall the devices can be minutely adjusted by an installer to compensate for any minor error in installation as to height or horizontal alignment.

The use of set screws and flutes securing the upper half of each device to the lower half fastens a frame to a wall in a manner that prevents accidental dislodging or mis-aligning of that frame by accident and prevents the unauthorized removal of that frame.

### DESCRIPTION OF VIEWS OF DRAWINGS

The invention, as illustrated in the drawings, consists of the following components and features. The invention uses pairs of identical devices with one of each pair attached to each side of a frame and those devices are then attached to a wall. Each device has two halves, the top half that is attached to the frame and the lower half that is attached to the wall. The top half is attached to the frame by screws which are placed through countersinked holes so that the screw heads are flush with the device when fully attached.

The upper half has a male part or tongue that is flanged at its end that mates or nests with the corresponding female slot of the lower half of the device. The side of the tongue has a flute on each side the tongue. The diameter of those flutes match the dimensions of the hemispherical ends of the set screws in the side of the lower half of the device.

The lower half of the device is attached to the wall by screws which are placed through countersinked holes so that the screw heads are flush with the device when fully attached. The screw holes of the lower half are drilled at an 11° angle from the horizontal. The lower half of the device has a female slot with a flange that mates with the tongue of the upper half. The lower half has two set screws with hemispherical ends that go into threaded holes on the sides of the lower half. The other ends of the set screws have slots that will accept a tool such as a wrench or screw driver with a unique shape that can tighten the set screws. The lower half has a set screw on the bottom that can extend into the slot where the tongue of the upper half nests such that the set screw contacts the bottom of the tongue and can raise the upper half of the device. The lower half of the device has an adhesive strip on the side that abuts the wall when installed. The adhesive strip has a low tack glue on each side. The adhesive strip extends a small distance onto the upper half where the upper and lower halves meet.

Various embodiments of the invention are shown by the following drawings:

FIG. 1 has isometric depictions of the upper and lower halves of the device showing the side that attaches to a wall.

FIG. 1A shows the upper and lower halves assembled together with the side set screws tightened.

FIG. 1B shows the upper and lower halves separated with the set screws removed from the lower half. FIG. 1B shows the flute on one side of the tongue with a concave dimension that matches the hemispherical diameter of the end of set screw on the sides of the lower half. FIG. 1B shows the groove in the flange on the female slot of the lower half that is an extension of the threaded hole for the bottom set screw on the lower half. That groove permits the lower set screw to extend into the female slot and raise the upper half of the device by pushing the tongue upward.

FIG. 1C shows the halves assembled with the adhesive strip attached to the lower half where there is a small overlap of the adhesive strip onto the upper half.

FIG. 1D shows the device halves separated with the adhesive strip attached to the lower half.

FIGS. 1E and 1F are wireframe isometric depictions of the device halves assembled and separated respectively showing the interior features of the device. FIG. 1F also shows the three set screws removed from the threaded holes.

FIG. 2 has isometric depictions of the upper and lower halves of the device showing the side that attaches to a frame.

FIG. 2A shows the upper and lower halves assembled together and FIG. 2B shows the upper and lower halves separated.

FIGS. 2C and 2D are wireframe depictions of the halves assembled and separated respectively showing the interior features of the device.

FIGS. 2B and 2D show the three set screws removed from the threaded holes.

FIG. 3 has depictions of the plan views of two devices showing the upper halves attached to a frame.

FIG. 3A shows a device attached to each side of a frame with the upper and lower halves assembled but omits the adhesive strip attached to the lower half with an overlap onto the upper half.

FIG. 3B shows a device attached to each side of a frame with the upper and lower halves separated but omits the adhesive strips attached to the lower halves.

FIG. 3C shows a device attached to each side of a frame assembled and shows the adhesive strips attached to the lower halves with an overlap onto the upper halves.

FIG. 3D shows a device attached to each side of a frame with the halves separated and shows the adhesive strips attached to the lower halves.

FIGS. 3E and 3F are wireframe depictions of the halves assembled and separated respectively showing the interior features of the devices when the upper halves are attached to a frame and omits the adhesive strips. FIG. 3F also shows the three set screws removed from the threaded holes.

FIG. 4 has depictions of the plan views of two devices showing the lower halves attached to a wall in alignment with the upper halves when the upper halves are attached to a frame. The outline of the frame is shown in FIG. 4 but the frame is otherwise transparent in the drawings.

FIG. 4A shows two devices attached to a wall with the upper and lower halves assembled.

FIG. 4B shows two devices attached to a wall with the upper and lower halves separated.

FIGS. 4C and 4D are wireframe depictions of the halves assembled and separated respectively showing the interior features of the devices when the lower halves are attached to a wall. FIG. 4D also shows the three set screws removed from the threaded holes.

FIG. 5 has wireframe depictions of the side view of the upper and lower halves of the device showing the interior features of the device and the use of screws and adhesive strip to attach the upper half of the device to the frame, the lower half to the wall and the assembling of the halves of the devices together thereby securing the frame to the wall.

FIG. 5A shows the halves of the device separated in a location between the frame and the wall where the device is be installed. The figure shows the horizontal angle of the screw holes drilled in the upper half of the device where screws would be directed into the frame and the 11° downward angle of the screw holes drilled in the lower half of the device where screws would be directed into a wall. FIG. 5A shows the flute in the male part of the upper half of the device and the set screw on the side of the lower half that is to be tightened into the flute. It shows the flange feature of the male part of the upper half of the device and the corresponding flange feature of the female part of the lower half. For illustration purposes, FIG. 5A also shows the adhesive strip separated from the lower half of the device, although an installer would not remove the strip from the device during installation.

FIG. 5B shows the upper half of the device screwed into the frame and the lower half being held onto the upper half by the overlap of the adhesive strip.

FIG. 5C shows the lower half of the device held onto the wall by the adhesive strip with the upper half of the device separated from the lower half.

FIG. 5D shows the upper half of the device screwed into the frame and the lower half screwed into the wall and positioned vertically in preparation of assembling the two halves together.

FIG. 5E shows the upper and lower halves of the device assembled together and held in place by the flanges of the male part of the upper half nested into the female part of the lower half and by the set screw on the side of the lower half tightened against the edge of the flute in the upper half.

### DETAILED DESCRIPTION OF INVENTION

The following is a detailed description of exemplary embodiments to illustrate the principles of the invention, which scope can encompass numerous alternatives, modifications and equivalents. The embodiments are provided to illustrate aspects of the invention, but the invention is not limited to any embodiment. Frames are the typical item this invention hangs on a wall but other items including mirrors, signs, shelves, decorations, trophies can be hung on a vertical surface using this invention. Walls are the typical vertical surface, but other surfaces such as fences can be used to hang items using this invention. Screws are the typical fastener used to attach the device to a frame or vertical surface but other fasteners could be employed. In this Detailed Description of Invention, references will be made to “frames”, “walls” and “screws” but the invention applies to their like.

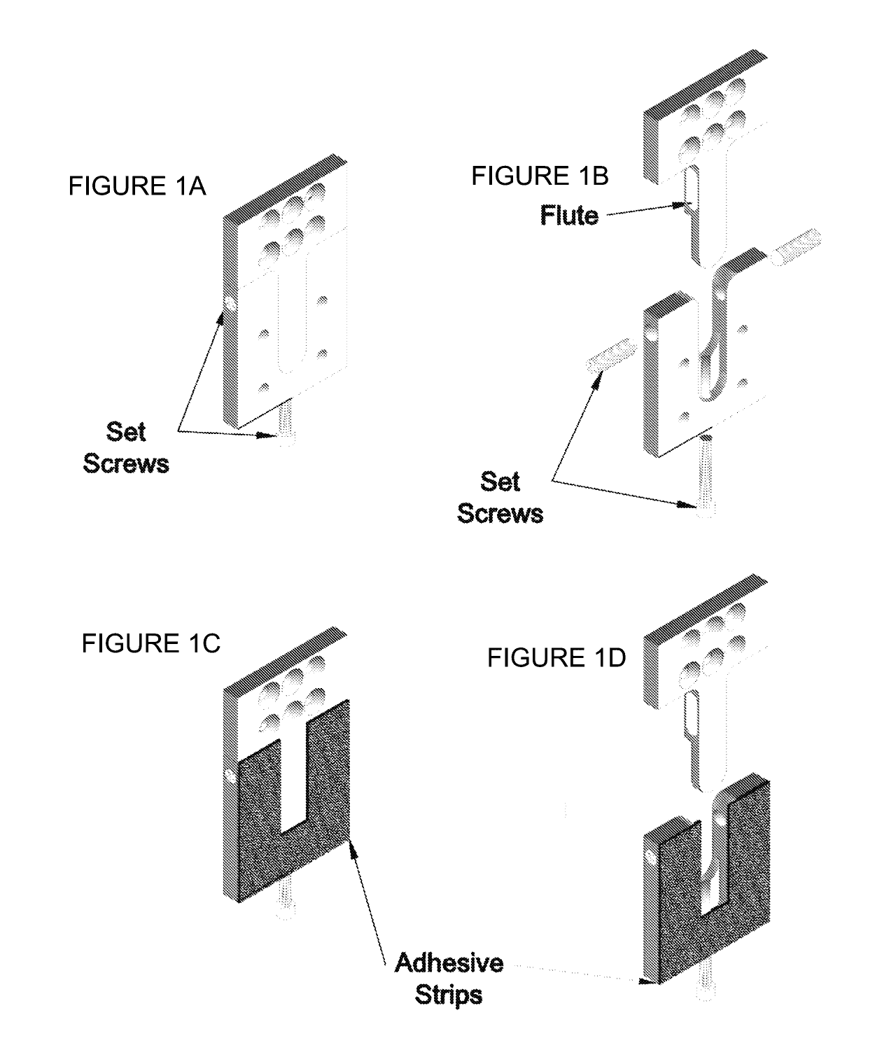

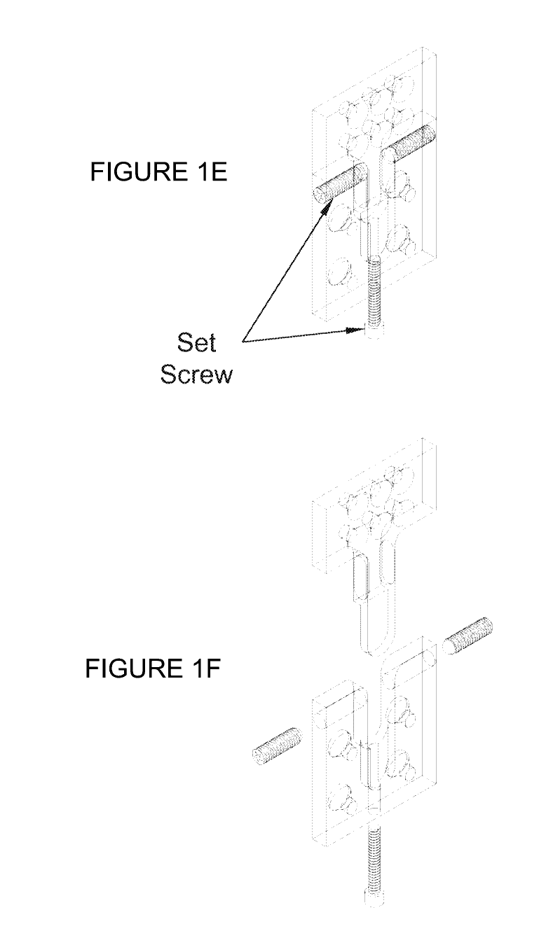

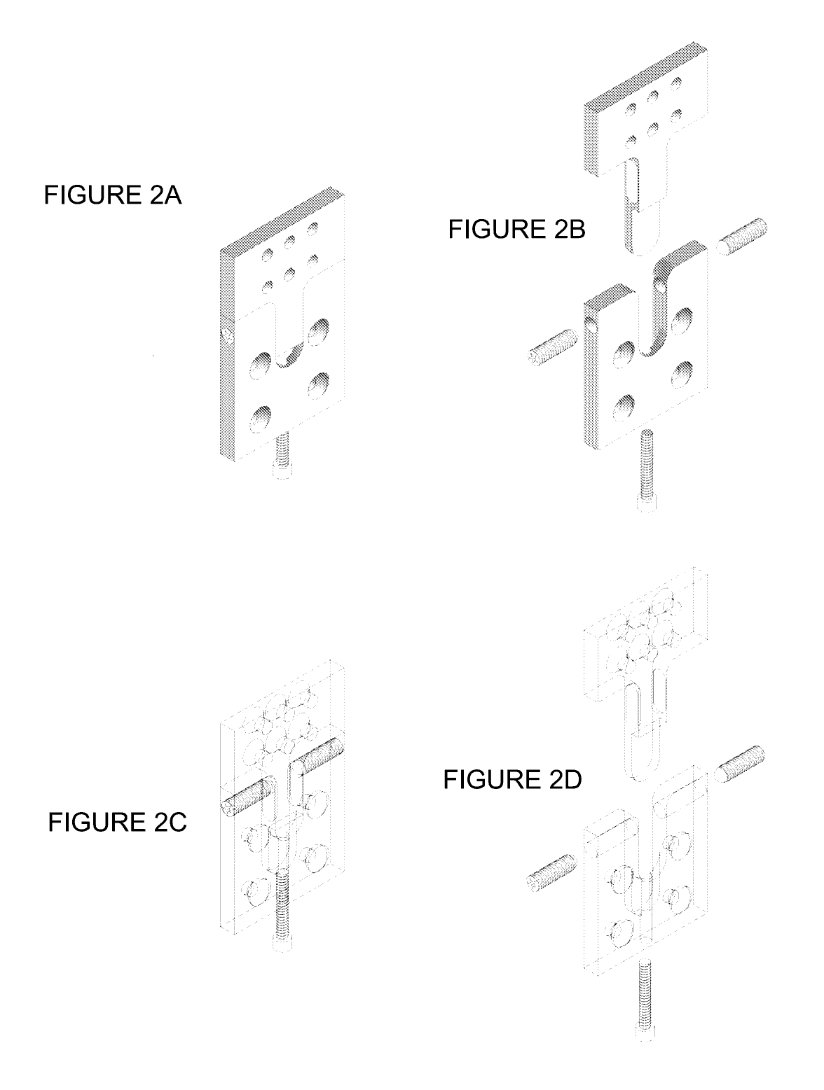

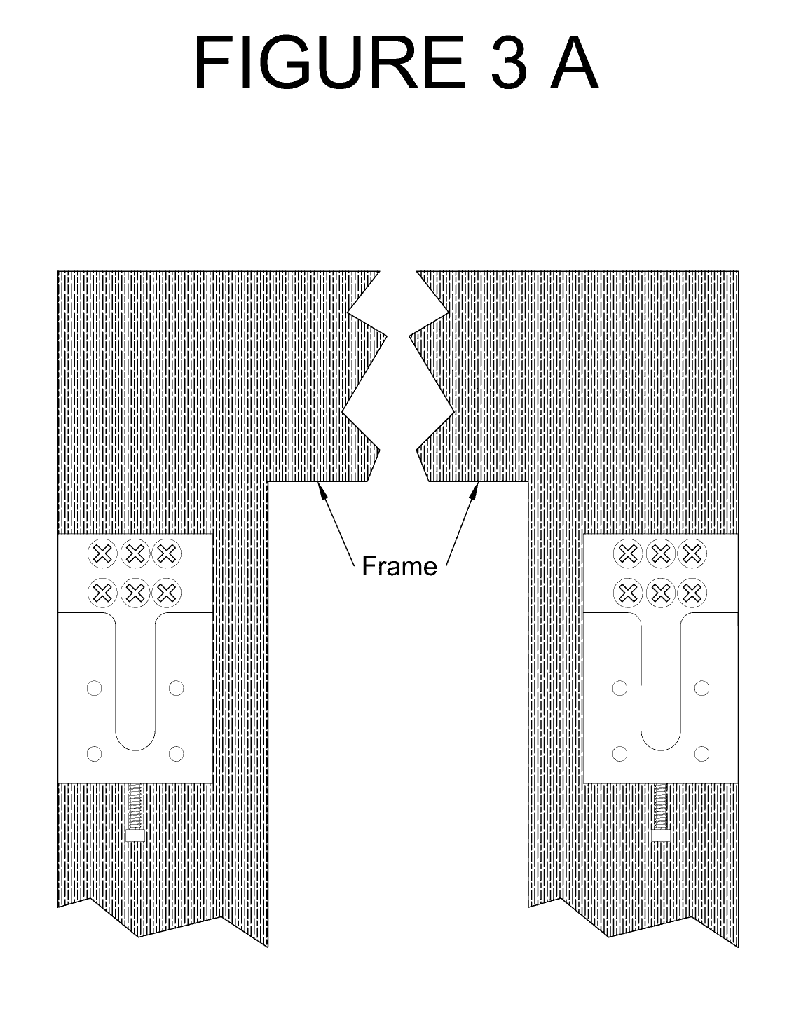

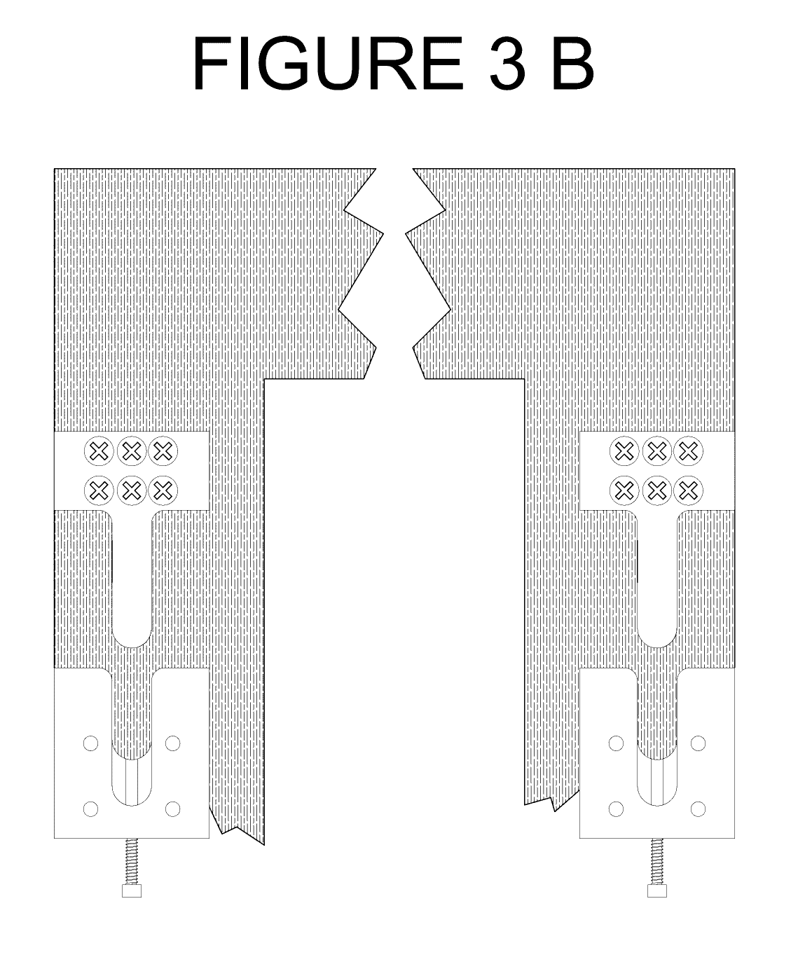

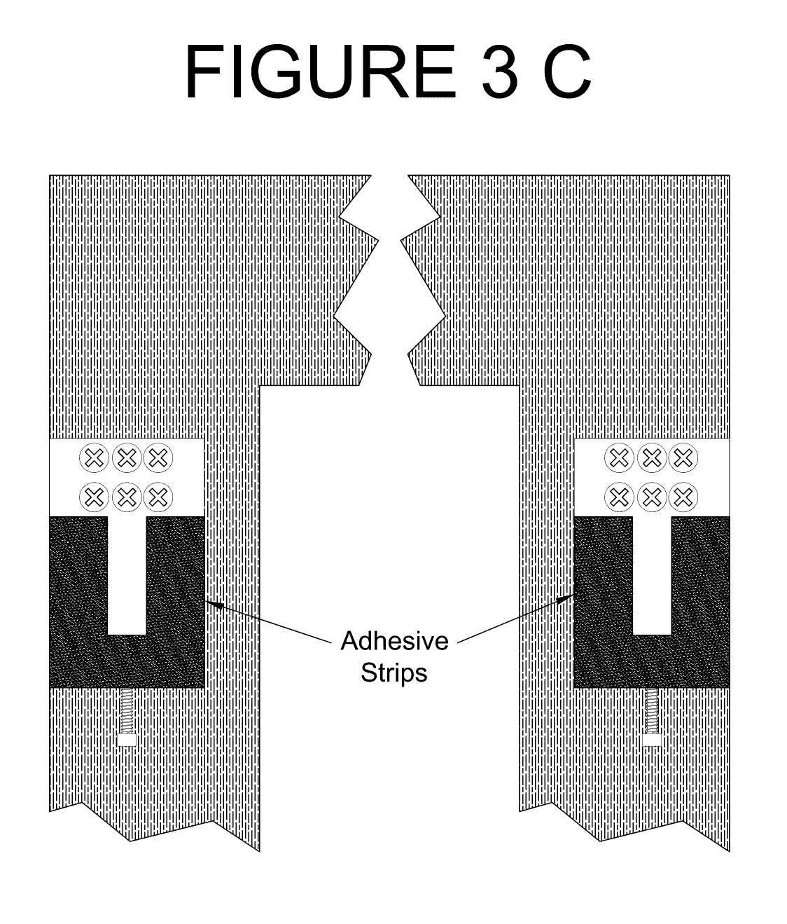

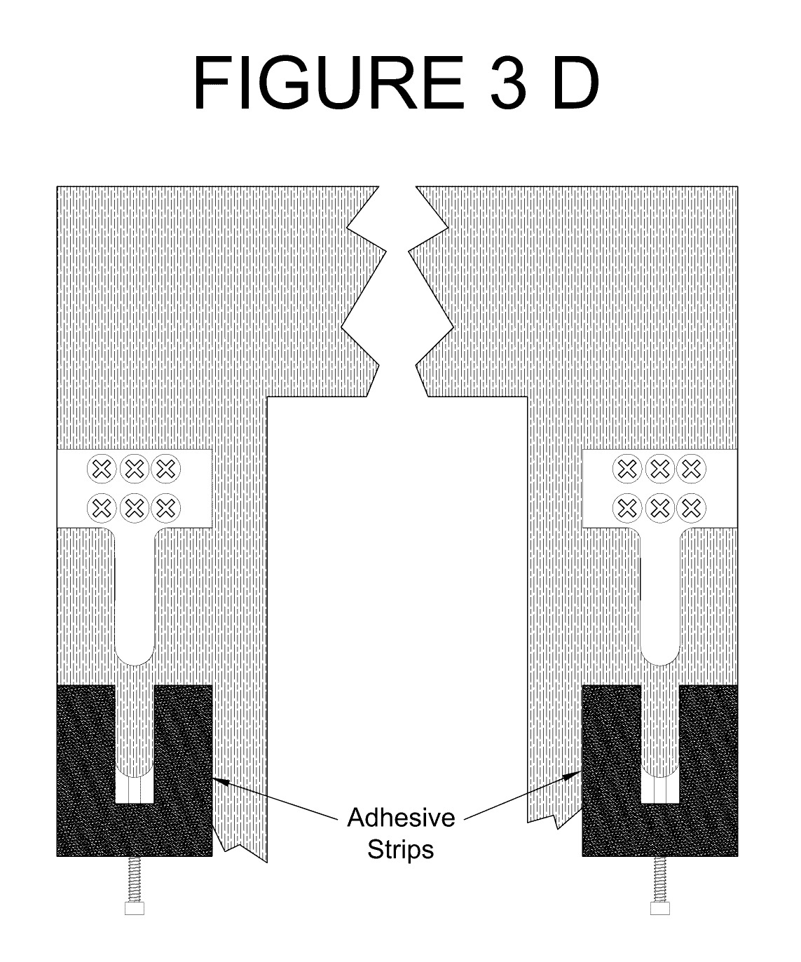

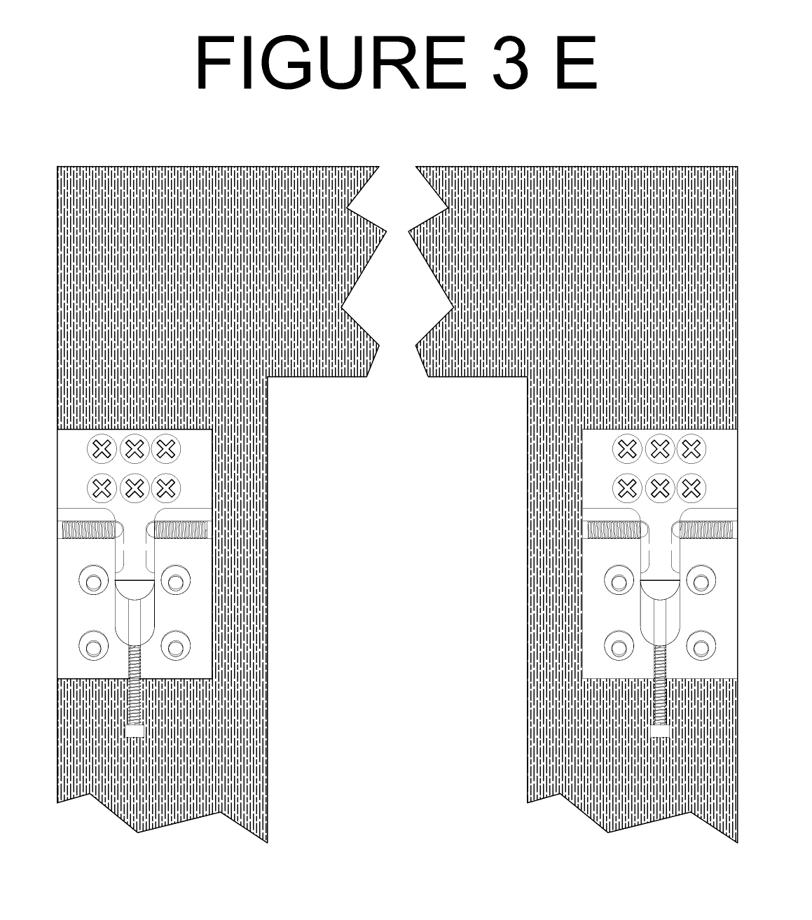

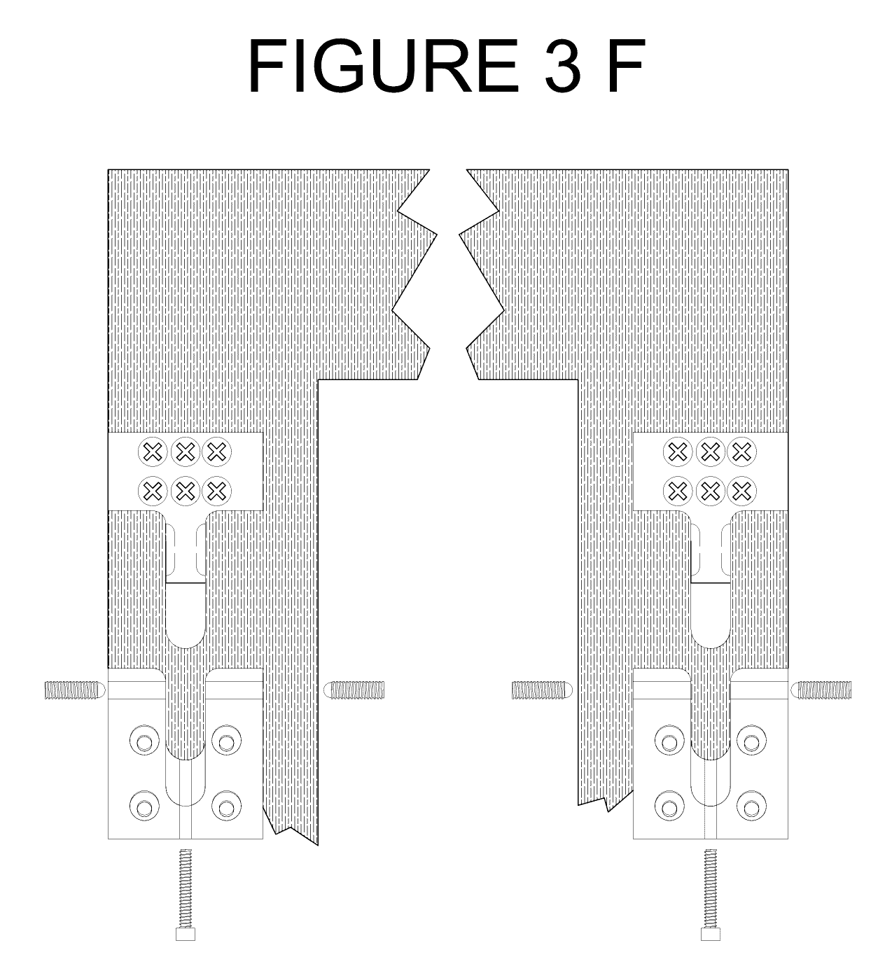

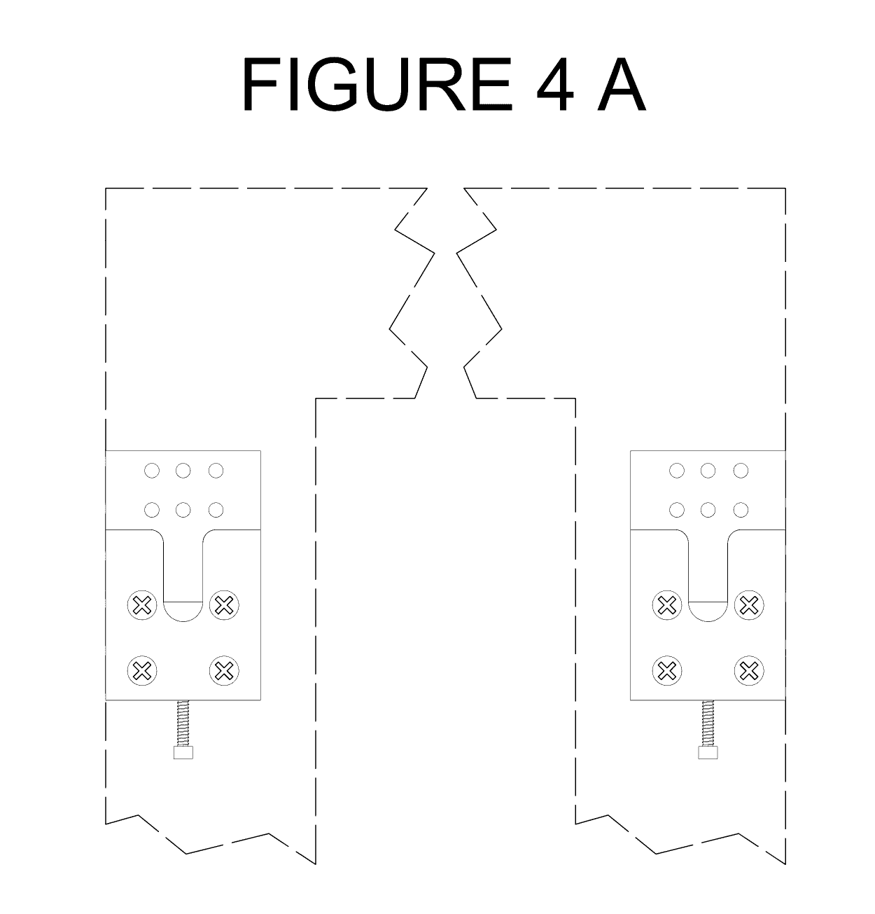

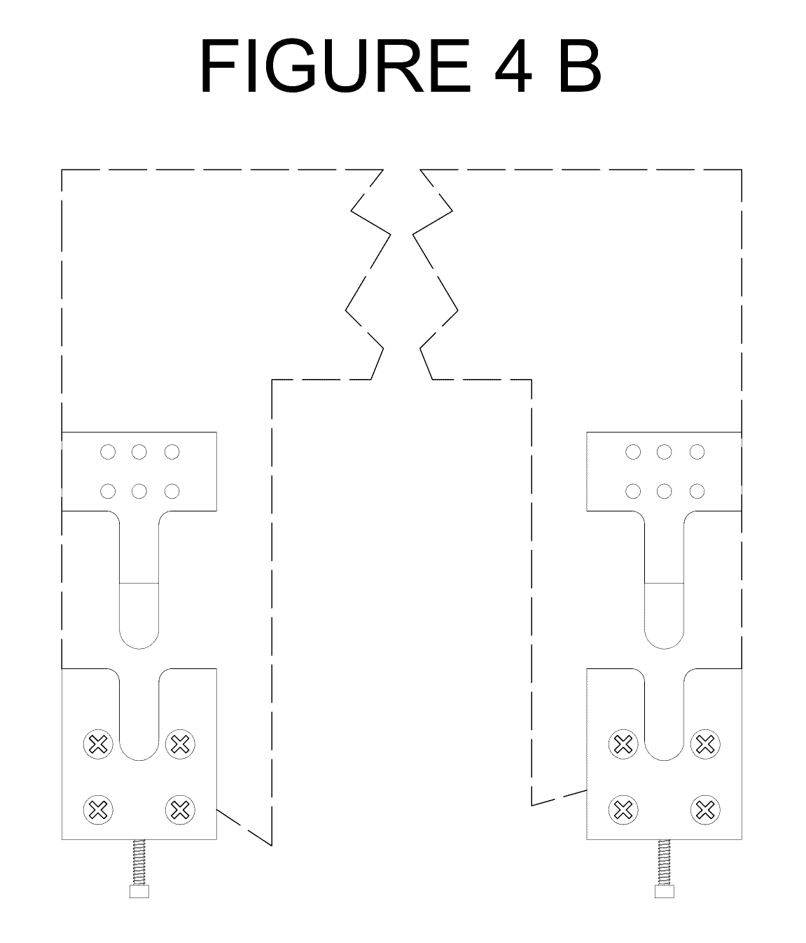

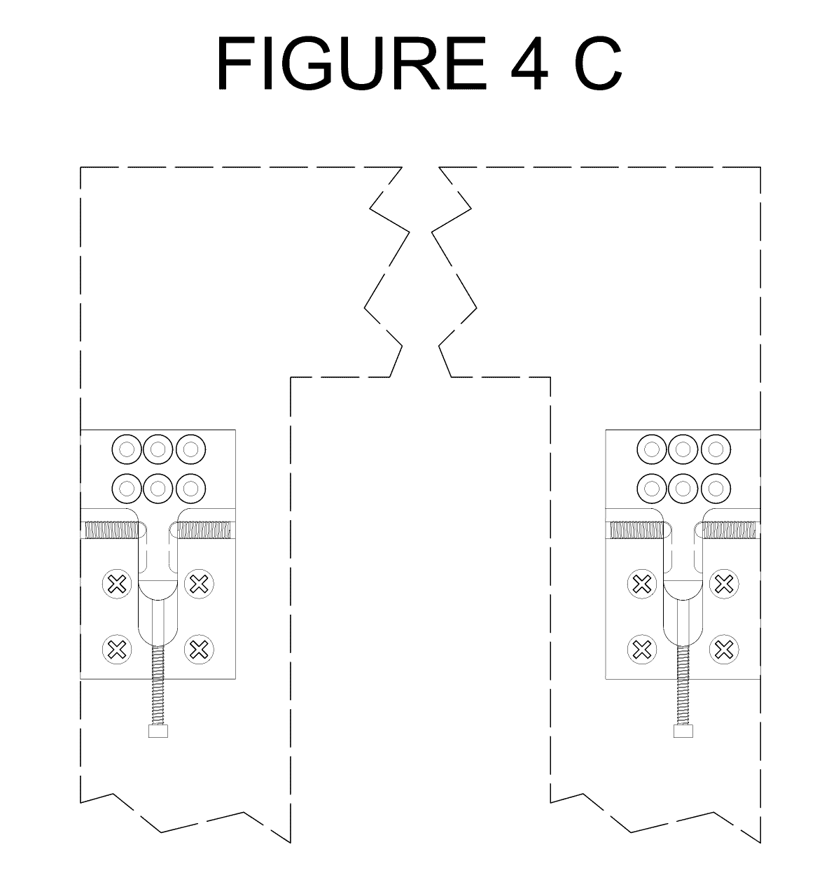

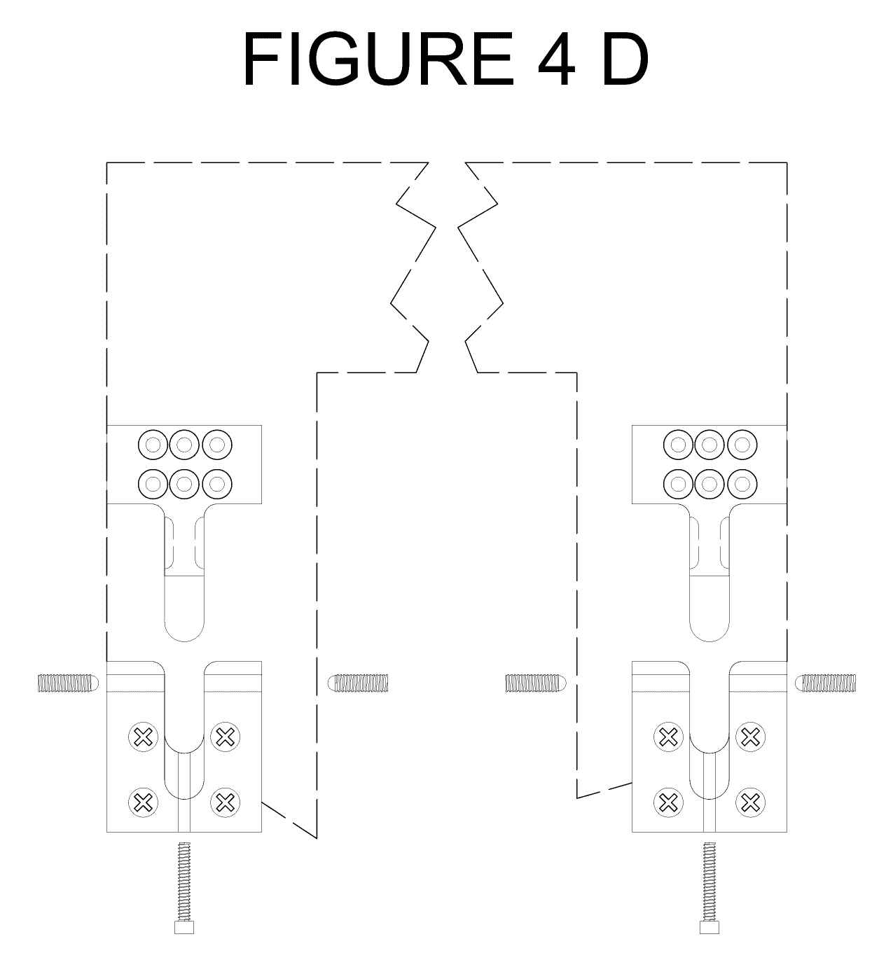

This invention typically uses two identical devices each of which consists of two parts: an upper half and a lower half as shown in FIGS. 1 and 2. Two devices are employed to hang a frame, one affixed to each side of a frame as shown in FIG. 3. If the vertical load or weight of the frame warrants additional devices, then one or more pairs of devices can be employed, with one of each pair being installed on each side of the frame. Once the devices are affixed to the frame then the frame is located on the wall where the adhesive strip holds the lower halves of the devices in place. The frame is then lifted vertically thus separating the upper and lower halves of the devices with the lower halves remaining attached to the wall held by the adhesive strips where they can then be permanently attached to the wall by screws. Once the lower halves are attached to the wall by screws the frame is returned to the desired position and desired alignment by nesting the upper and lower halves of the devices. A minor adjustment to the vertical position and alignment of the frame may be accomplished by the set screws and flute in the device. The side set screws are tightened so that they extend into the flutes of the upper halves resulting in two halves of the devices being secured together and the frame secured to the wall. A more detailed description of the invention follows.

The devices are presented to an installer with each half together as shown in FIGS. 1A and 2A with low-tack adhesive strips attached to the lower halves of the devices with a small overlap onto the upper halves of the devices as shown in FIG. 1C. The presentation of devices to an installer has the set screws screwed into the threaded holes on the sides of the lower halves of the devices but the heads of the set screws do not extend into the fluted cavities of the male parts of the upper halves; the set screws in the bottoms of the lower halves are screwed into the threaded holes but do not extend into female parts of the lower halves. This is illustrated in FIGS. 1E and 2C. It is the overlap of the adhesive strips onto the upper halves that keeps the upper and lower halves together until the halves are intentionally separated during installation. The adhesive strips are presented with non-stick liners on the side not attached to the device; the liners are removed during the installation process as described below.

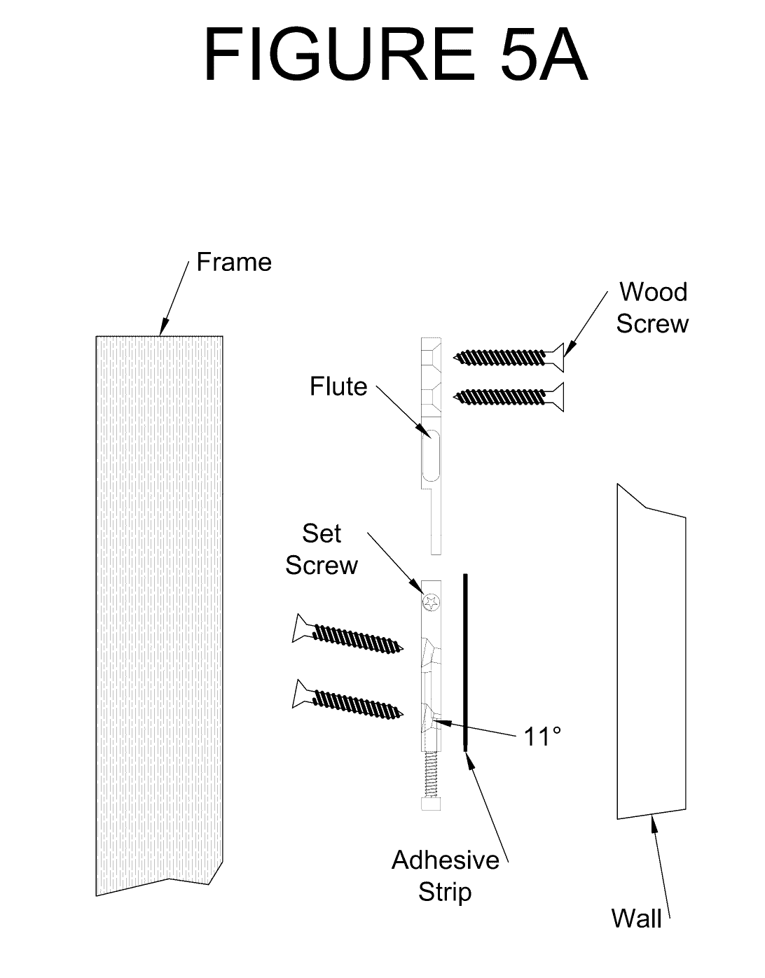

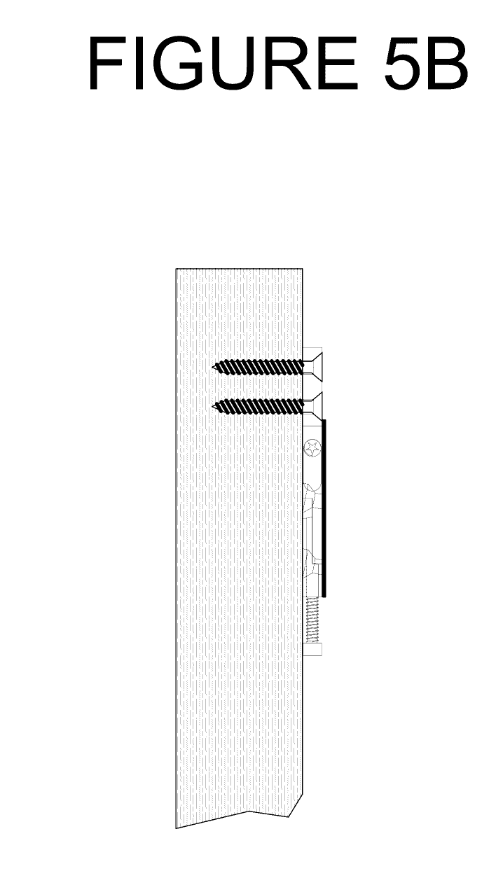

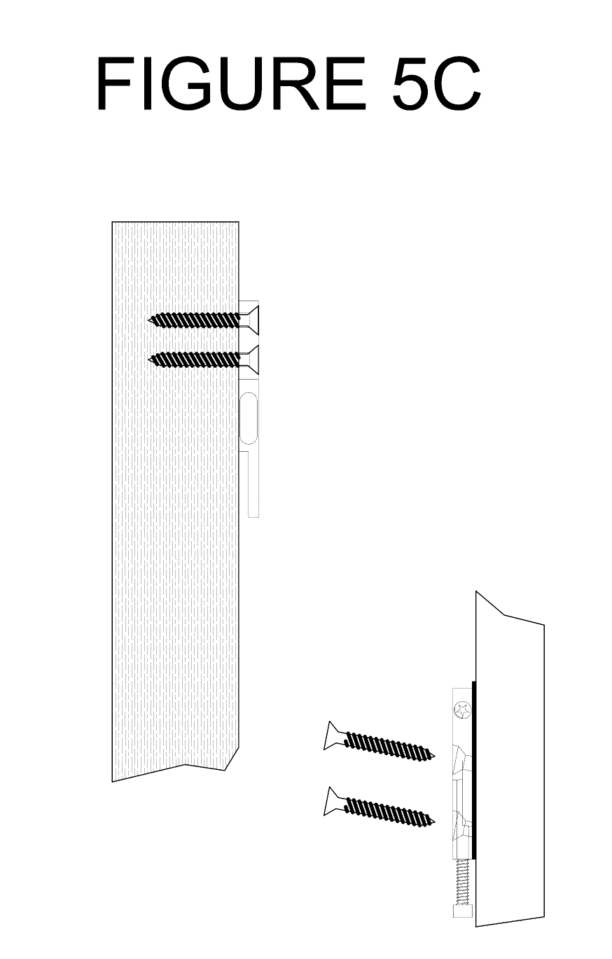

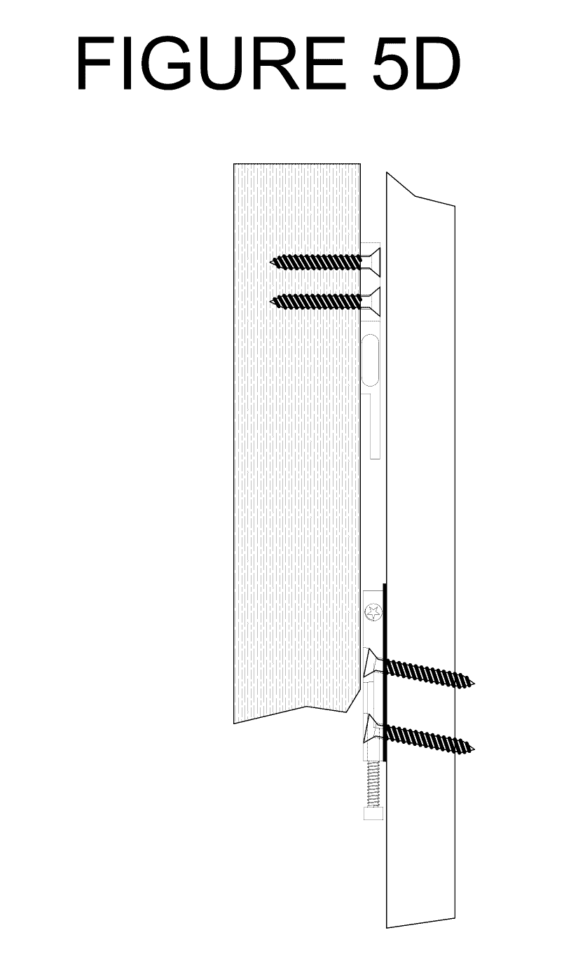

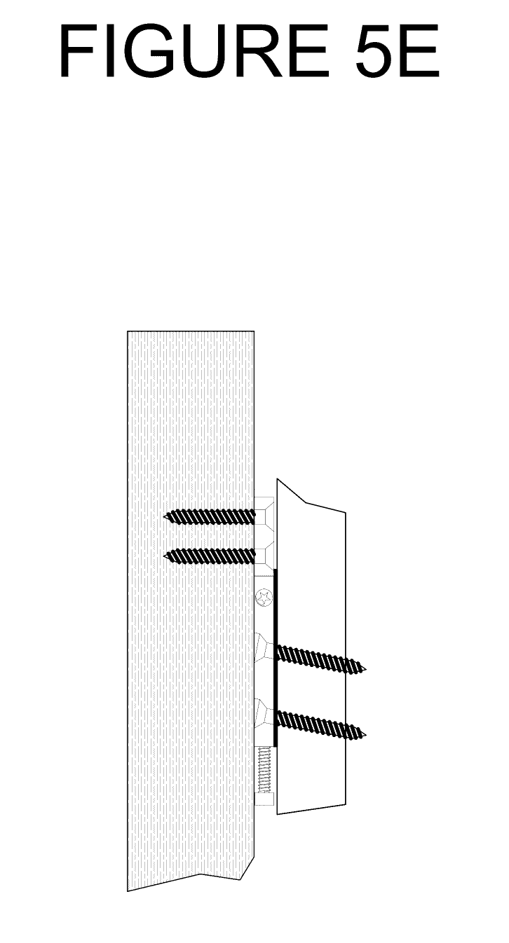

This invention is employed by first aligning the outer edges of the devices with the outer edges of the frame. Although each device should be affixed to the respective side of a frame at a similar distance from the top of the frame this invention does not require that the distances be precisely identical. The upper halves of the devices are then affixed to the frame by screws through holes drilled in the upper halves. The lower halves of the devices will remain held to the upper halves by the overlap of the adhesive strips. The screws are placed in the holes drilled in the upper halves and then tightened into the frame until the heads of the screws are flush with sides of the devices. The result of this first step is shown in FIGS. 3C and 5B.

Once the devices are affixed to the frame, the installer then removes the non-stick liners from the adhesives strips on the lower halves of the devices exposing the adhesive layer facing the wall side of the frame. The installer then places a level on the top (or some other rectilinear part) of the frame so the installer can determine horizontal or vertical alignment. Such a level can either rest on the frame surface or can be temporarily attached by a number of means, including the use of glue, tape or clamps. With the level on the frame and the adhesive exposed on the wall side of the lower halves of the devices, the installer then locates that frame on the desired location on a wall with the proper horizontal alignment achieved by referring to the level. When the desired location with proper alignment is found, the installer then firmly presses the frame against the wall and the adhesive then holds the lower halves of the devices in the selected place on the wall. The installer then raises the frame vertically separating the upper halves of the devices from the lower halves, with the lower halves remaining on the wall held by the adhesive. This is shown in FIG. 5C. The installer can then place the frame aside with the upper halves of the devices affixed to it.

The installer then permanently attaches the lower halves of the devices into the wall at the locations where they are held by the adhesive by placing screws through the holes drilled in the lower halves of the devices and installing the screws until the screws are flush with the edge of the device. The lower halves of the devices are drilled so that the screws are directed into the wall at an approximate 11° downward angle. The screws are tightened into the walls (and through the adhesive strips) until the heads of the screws do not protrude past the edge of the devices.

Once the lower halves of the devices are permanently attached to the wall then the frame is returned to the wall with the male parts of the upper halves of the devices placed into the female parts of the lower halves. This positioning of the upper and lower halves of the devices when they are affixed to the frame and attached to the wall is shown in FIGS. 3B (without adhesive strips depicted), 3D (with adhesive strips depicted), 4B and 5D. Note that the set screws in the lower halves of the devices never extend into the female part of the lower halves until all adjustments are accomplished as an improperly extended set screw could prevent the complete nesting of the lower and upper halves of the devices.

Once a frame is hanging on the wall with the upper and lower halves of the devices nested together, the devices are designed to permit minor but significant adjustments to allow a more precise vertical location on the wall and a more squared alignment. This is accomplished by use of set screws in the bottom and side of the lower halves of the devices and the flutes in the sides of the male part of the upper halves that align with the side set screws of the lower halves. To raise an entire frame, an installer adjusts the set screws in the bottoms of both lower halves of the devices an equal distance. To adjust the alignment of a frame, an installer adjusts the set screw in the bottom of the lower half of the device for the side that needs to be raised to achieve horizontal alignment.

Once the height and alignment of a frame is accomplished, the installer then tightens the set screws on the sides of the lower halves of the devices. This holds the adjustment in place because the diameter of the hemispherical end of the set screws is the same as the diameter as the flute cavities in the male part of the upper halves of the devices. This matching of diameters achieves the maximum friction between the surface areas of the set screws and flutes. The set screws will then hold a frame at the adjusted height and alignment.

When the upper and lower halves of the devices are nested together the vertical load (or weight) of the frame is held by the assembled devices as affixed to the frame and attached to the wall. This configuration is shown in FIGS. 3A (without adhesive strips depicted), 3C (with adhesive strips depicted), 4A and 5E. The manner of the fit of the flanges on the male part of the upper halves of the devices into the female part of the lower halves prevents a frame from moving horizontally away from a wall, as shown in FIGS. 5B and 5D. That design also prevents rotation along the latitudinal axis of the frame. Because the male parts of the upper halves of the devices have flutes and not simply grooves, the male parts cannot be lifted out from the female parts of lower halves as the bottom of the flutes will be stopped by the set screws and prevent removal without first loosening the set screws. The set screws have a unique head (i.e., not a hex or square shape) that can only be turned with a matching wrench or screw driver of the same shape and dimension thus preventing a person without the appropriate tool from loosening the set screws and removing the frame by separating the halves of the devices.

If the vertical load or weight of a frame is such that more than two devices are necessary then two or more additional device pairs can be used by affixing one of each pair to each side of a frame and then attaching them to a wall in the same manner as a single pair of devices.

This invention permits the installation of a frame on a wall using the devices and a level that without first making preliminary measurements or marks on a wall to achieve the desired location with proper alignment. The invention allows minor adjustment to correct any misalignment or mis-location that is too low. Once the alignment and location is accomplished the set screws and flutes secure the frame in place and prevent accidental misalignment or mis-positioning when hit or bumped into. The set screws and flutes prevent the removal of a frame from a wall without use of the appropriate unique tool.

The disclosed embodiments are illustrative but not restrictive. While specific configurations of this wall hanging system devices have been described, this invention can be applied to a variety of items that can be hung on a wall. There are alternative ways of implementing this invention.

What is claimed:

1. A system and method for securely hanging picture frames, mirrors or like to a wall or other vertical surface comprising:
two identical devices (or additional pairs of devices) that are to be attached in pairs, one to each side of a frame;
where the devices have two mating halves with flanged male and female parts;
such that when the halves of the devices are assembled together and secured;
by a set screw with a hemispherical end;
that inserts through a threaded hole in the lower half of the device;
which is tightened against, and secured into, a flute on the male part of the upper half of the device;
which flute has a concave dimension that matches the diameter of the hemispherical end of the set screw;
so that when the two halves of each device are attached;
the upper half to the frame; and
the lower half to the wall;
and then the two halves are nested together and secured with set screws by a special tool;
the frame cannot be dislodged, misaligned or removed intentionally or unintentionally;
without using the special tool to loosen the set screws.
The design of the devices secures a frame to a wall permanently so that it cannot be dislodged, misaligned or removed intentionally or unintentionally by grasping, knocking or hitting the frame or by shaking or vibrating the frame or the wall;
because once the devices are attached by screws (or other fasteners);
the upper half to the frame; and
the lower half to the wall;
those screws cannot be accessed and unscrewed (or loosened) after the halves of the devices are assembled and secured by the set screws in the side of the lower halves of the devices, because the flanges on the male and female parts of the devices, along with the set screws tightened into the flutes, prevent the devices from being separated or moved horizontally from the wall, and because the flutes prevent the set screws from moving past the narrowing and shallowing part of the flutes so the upper and lower halves of the devices cannot be separated and the frame cannot move vertically without the set screws first being loosened with the special tool. Thus this invention secures a frame, mirror or like to a wall or other vertical surface so that it cannot be dislodged or misaligned unintentionally and cannot be removed intentionally by a person without use of a special tool.

2. A system and method for accurately hanging picture frames, mirrors or like at a precise location with exact horizontal or vertical alignment on a wall or other vertical surface comprising:
two identical devices (or additional pairs of devices) that are attached in pairs, one to each side of a frame;
with two-sided adhesive strips adhering to the wall-sides of the lower halves of the devices;
that have a small overlap of the adhesive strip onto the upper halves of the devices;
that overlap keeps the upper and lower halves together after the upper halves are attached to the frame;
however, the overlap is small enough to permit the upper and lower halves of the devices to separate after the lower halves are placed on and are adhering to the wall; and
the adhesives strips are not designed to hold the frame to the wall for a length of time but simply to briefly hold the lower halves of the devices in the appropriate position on the wall, the lower halves being permanently held by screws into the wall;
the location of the frame on a wall can be chosen by an installer holding the frame in the desired location;
the horizontal or vertical alignment of the frame can be accomplished by using a level resting on or attached to the frame;
once wall location is chosen and alignment is achieved the location of the devices is accomplished by simply applying firm pressure which causes the lower halves of the devices to remain in the proper place on the wall;
the lower halves of the devices are permanently attached to the wall by screws giving the devices the ability to hold a much greater vertical load than an adhesive attachment can achieve;
after the lower halves of the devices are screwed into the wall then the upper halves of the devices mechanically fit into the corresponding place in the lower halves of the devices putting the frame in the exact same location and alignment as previously selected.
The frame can be further aligned and positioned;
by using the set screws on the bottom of the lower halves of the devices to raise either one side or both sides of the frame;
to adjust the alignment by raising the side of the frame that needs to be lifted to achieve level alignment; or
to raise both sides of the frame to achieve a higher desired location; and
the selected adjustment is maintained by the tightening the set screws in the side of lower halves of the devices.
